(19) United States
(12) Patent Application Publication
(10) Pub. No.: US 2009/0094522 A1
(43) Pub. Date: Apr. 9, 2009

(54) Interactive presentation and distribution of web content

(75) Inventors: Bin Tu, Clarksburg, MD (US); John J. Brier, Pensacola, FL (US)

Correspondence Address: GREENBERG TRAURIG, LLP, ONE INTERNATIONAL PLACE, 20th FL, ATTN: PATENT ADMINISTRATOR, BOSTON, MA, 02110, US

(73) Assignee: Tinbu, LLC

(21) Appl. No.: 11/906,901

(22) Filed: Oct. 4, 2007

(51) Int. Cl. G06F 3/00

(52) U.S. Cl. 715/738

(57) ABSTRACT

A data module for display in web content on a webpage is disclosed, along with a method of presenting the web content. The module includes data content for display on a webpage having publisher content, an advertisement coupled to the data content, and a link in the data content for allowing a viewer of the webpage to manipulate the data content. The method includes generating a data module by coupling an advertisement to data content, providing at least one link in the data module for allowing a viewer of the webpage to manipulate the data content, displaying the data module on a webpage having publisher content, and refreshing the webpage, in response to receiving a selection of the link from the viewer, to display the manipulated data content and advertisement in the data module on the webpage.

### TECHNICAL FIELD

This invention relates generally to the field of distributed web content, and more particularly to the generation and presentation of interactive web content across computer and communication networks.

### BACKGROUND ART

A growing segment of media properties, including web sites, portals, cellular telephone companies, short message service (SMS) messaging companies, and other groups are looking for ways to get web content and present it to their customers or visitors. Furthermore, a growing number of companies globally are looking for ways to advertise their products and services to targeted audiences of viewers who are interested in particular types of web content and information, such as, lottery results, sports, finance, entertainment, weather, flight tracking, fuel pricing, and other fields.

As such, it would be desirable to provide a system where data or information can be collected and presented to those interested in such information in an interactive manner.

### SUMMARY OF THE INVENTION

The present invention further provides a method of presenting web content on a webpage. The method includes generating a data module by coupling an advertisement to data content, providing at least one link in the data module for allowing a viewer of the webpage to manipulate the data content, displaying the data module on a webpage having publisher content, and refreshing the webpage, in response to receiving a selection of the link from the viewer, to display the manipulated data content and advertisement in the data module on the webpage. Refreshing the webpage includes displaying additional advertisements in the data module.

In another embodiment, the present invention provides a data module that can be embedded in and displayed on a webpage. The data module includes data content pertaining to a particular topic for display on a webpage. The data content can be displayed on the webpage independent of publisher content displayed on the webpage. The data module can further include an advertisement that can be presented within the data content, and a link in the data content for allowing a viewer of the webpage to manipulate the data content.

In another embodiment, the present invention provides a method of presenting web content to increase page views of a webpage. The method includes displaying publisher content on a webpage, exhibiting data content on the webpage, providing at least one link in the data content for allowing a viewer of the webpage to manipulate the data content, and refreshing the webpage, in response to receiving a selection of the link from the viewer, to present the manipulated data content on the webpage.

In another embodiment, the present invention provides a method of presenting a data module on a webpage to increase the number of advertisements presented to a viewer of the webpage. The method includes displaying a data module having data content and at least one advertisement on a webpage having publisher content, providing at least one link in the data module for allowing a viewer of the webpage to manipulate the data content in the data module, and refreshing the webpage, in response to receiving a selection of the link from the viewer, to display the manipulated data module on the webpage.

In an aspect, the invention features a data module that can be embedded in and displayed on a webpage. The data module includes data content, pertaining to a particular topic, for display on a webpage. The data content can be displayed independent of publisher content displayed on the webpage. The data module can further include a geographically targeted advertisement presented within the data content, and a link in the data content for allowing a viewer of the webpage to manipulate and interact with the data content.

One or more of the following features may also be included. The advertisement can include audio and/or video components that can be presented to the viewer in response to receiving a selection of the link from the viewer. The advertisement can be specific to the publisher content on the webpage. The advertisement can be specific to the data content on the webpage. The advertisement can include an associated HTML link that can be displayed in the data content on the webpage. The link in the data content for allowing a viewer of the webpage to manipulate and interact with the data content can be an HTML link.

In another aspect, the invention features a method of presenting web content on a webpage. The method includes generating a data module by coupling a geographically targeted advertisement to data content, providing at least one link in the data module for allowing a viewer of the webpage to manipulate the data content, displaying the data module on a webpage having publisher content, and refreshing the webpage, in response to receiving a selection of the link from the viewer, to display the manipulated data module on the webpage and present the advertisement to the viewer.

One or more of the following features may also be included. Displaying the data module can include distributing the data module to multiple websites or a network of websites. Refreshing the webpage can include displaying additional advertisements in the manipulated data module.

Refreshing the webpage can include presenting the advertisement to the viewer in an audio or video format. Refreshing the webpage can include presenting the advertisement as specific to the publisher content. Refreshing the webpage can include presenting the advertisement as specific to the data content.

### BRIEF DESCRIPTION OF DRAWINGS

FIG. 1 illustrates components of a data content and advertising platform for use in connection with the present invention.

FIG. 2 illustrates a data content and advertising platform in accordance with one embodiment of the present invention.

FIG. 3 illustrates a system level architecture for use in connection with one embodiment of the present invention.

FIG. 4 illustrates a network architecture for use in connection with an embodiment of the present invention.

FIG. 5 illustrates a webpage display configured in accordance with one embodiment of the present invention.

FIG. 6 illustrates an arbitrary HTML source sample for use in connection with one embodiment of the present invention.

### DESCRIPTION OF SPECIFIC EMBODIMENTS

Generally, in an embodiment, the present invention provides a system and method of presenting web content on one or more websites via a computer or communication network. The web content can be configured as a data module that can be embedded and displayed on a webpage. The data module can include data content, an advertisement coupled to the data content, and a link in the data content for allowing a viewer of the webpage to manipulate and interact with the data content. In response to a viewer selecting a link in the data content, the webpage can be refreshed to display the manipulated data content and advertisements.

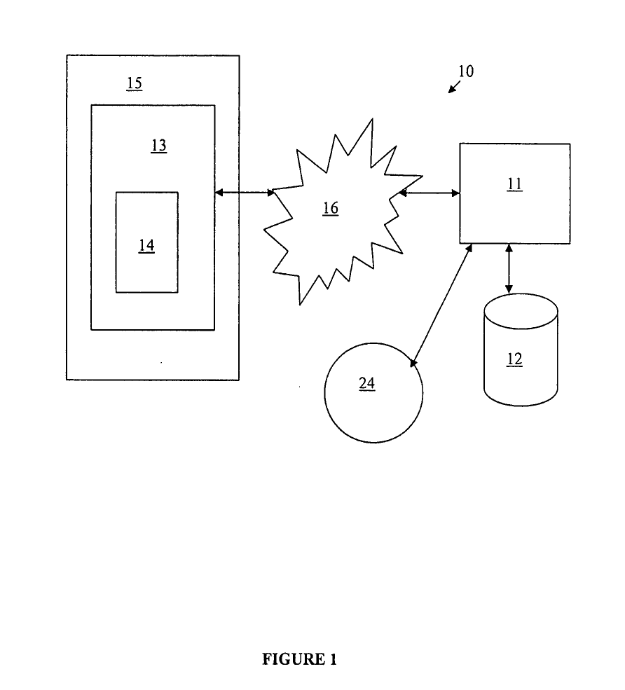

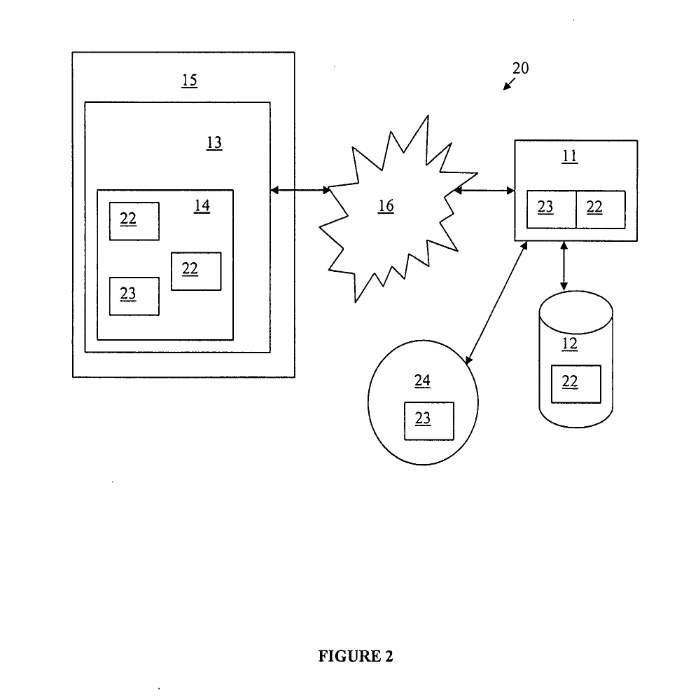

Referring to FIG. 1 and FIG. 2, a content provider platform 10 can be designed to supply client websites 13 and wireless services with web content 14, which in one embodiment, can be configured as a data module. The web content 14 can include interactive data content 22 and advertisements 23. Interactive data content 22 can include data content having one or more links, such as HTML links, which a viewer can select to interact with the data content 22. The data content 22 can include text, graphics, JPEGS, MPEGS, and so forth.

The data content 22 can be specific and configured to appeal to a particular audience. For instance, the interactive data content 22 can include lottery data, horoscope data, entertainment data, health data, financial data, or sports data. The interactive data content 22 can be presented in various languages including English, German, French, Chinese, and Spanish. The data content 22 can also be tailored based on cultural and societal norms of a particular region or country.

Displaying interactive data content 22 on a website 13 can increase the interest level of a viewer, and can prolong the presence of the viewer at the particular website 13. In turn, a prolonged viewer presence can result in greater content utilization, more page views, and repeat visits to the website 13. The prolonged viewer presence also increases the exposure of the viewer to the content-specific advertisements, thereby resulting in more advertisement conversions (selections/clicks, purchases, views), and increased revenues.

In particular, a digital data processor 11 can provide web content 14 that includes both interactive data content 22 and content-specific advertisements 23 to one or more websites 13 operating on client platforms 15. The processor 11 can be implemented in software, firmware, or a combination of hardware and software. In an embodiment, the processor 11 can be linked to the websites 13 via a computer or communications network 16, for instance, a LAN, WLAN, WAN, Internet, etc. The content 14 can be specific, and tailored for the viewing audience of the particular website 13. For example, if the particular website 13 pertains to fishing, the data content 22 provided by processor 11 can be results of various fishing sporting events. Similarly, the content-specific advertisements 23 provided by processor 11 can be directed to fishing equipment vendors, fishing tournaments, clothing, or other fishing related products or information. In an embodiment, the content specific advertisements can be displayed in and around the data content.

In one embodiment, the content 14 provided to a website 13 by processor 11 can be stored in a data store 12. The data store 12 can also contain various information pertaining to client websites 13. The information in the data store 12 can include predefined content parameters, and identifiers that are unique for each content recipient and client website 13. Processor 11 can utilize the unique identifiers to extract data content 22 pertaining to a particular client website 13 from the data store 12.

Specifically, when a viewer of webpage 13 generates a request for content by selecting a link in the displayed content 14, that request can be received and handled by the processor 11. In an embodiment, the processor 11 can respond to the request by extracting information, for instance an identifier and type of data, from the request, and using the information to retrieve corresponding data content 22 from the data store 12. The processor 11 can then utilize predefined parameters stored in data store 12, which pertain to the type of content (lottery, horoscope, weather, etc.) displayed on the client website 13, to dynamically request one or more advertisements 23 at runtime from an advertisement provider 24, for instance, Yahoo or Google.

In particular, the processor 11 can select one or more predefined parameters from data store 12 that most closely match the type of content displayed on the webpage 13. The processor 11 can pass the selected parameters at runtime via a function call to an ad server of the provider 24. The ad server of the provider 24 responds to the function call by returning one or more advertisements 23 corresponding to the predefined parameters to processor 11. The closer the correlation between the selected parameters and the displayed content, the more relevant and content-specific the advertisements 23 can be. The processor 11 can then distribute the received advertisements 23 and data content 22 to the requesting webpage 13 as web content 14. In an embodiment, the processor 11, can utilize a JavaScript to dynamically update and rewrite the webpage 13 to include the requested data content 22 and advertisements 23 in the web content 14.

In an embodiment, processor 11 can select, based on predefined preferences and parameters stored in data store 12, which data content recipients are to receive content-specific advertisements 23, and what specific advertisements are to be supplied to a particular recipient or website 13. This allows advertisement providers 24, such as Google and Yahoo, to reach a substantial audience at one time without having to rely on working with individual website properties or groups to present advertising. For example, if Google, Yahoo, or any other advertisement provider 24 wants to have their content-specific advertisements 23 appearing at some, or all of the data content recipients' websites 13, then that preference can be stored in the data store 12. Thereafter, upon receiving advertisements from the particular provider 24, the processor 11 can extract the preference information from data store 12, and can distribute the advertisements to the various websites 13.

The processor 11 can integrate the content-specific advertisements 23 with the interactive data content 22 in various formats, including text links, video files, banner ads, sliders, etc. The recipients of the data content 22 and content-specific advertisements 23 can include media groups, such as, AOL, AOL Telemundo, MSN, MSNBC, ABC Television, NBC Television, CBS Television, CBS Radio, USA TODAY, Washington Post, ATT, Bell South, Media General, Toronto Star, AOL Canada, MSN Espanol, Quepasa, Clear Channel Television, Motricity, mFoundry, My Red Fish, Local Solutions Network, and others.

In another embodiment, requests for specific data content and advertisements can be generated by the recipient client websites 13 or wireless services and sent to processor 11 in real-time. This configuration allows the recipients to customize the data content 22, and advertisements 23 that they receive from processor 11. Upon receiving the requests, the processor 11 can aggregate various data components from data store 12 to form the requested interactive data content 22. Processor 11 can then integrate advertisements 23 with the interactive data content 22 to form the customized web content 14, which can then be distributed to the recipients for subsequent use in their wireless services or websites 13.

In an embodiment, processor 11 can be configured to provide web content 14, including interactive data content 22 and content-specific advertisements 23 to multiple client websites 13. Processor 11 can receive the specific advertisements 23 from providers 24, such as, Google, Yahoo, and Advertising.com. The processor 11, can integrate the content-specific advertisements 23 with interactive data content 22 and can distribute the integrated content to particular client websites 13 and wireless services. The processor 11 provides the specific data content 22 to the appropriate websites 13 along with the content-specific advertisements 23. In this manner, the provider 24 can propagate its advertisements 23 throughout some, or all of the websites 13 serviced by the processor 11.

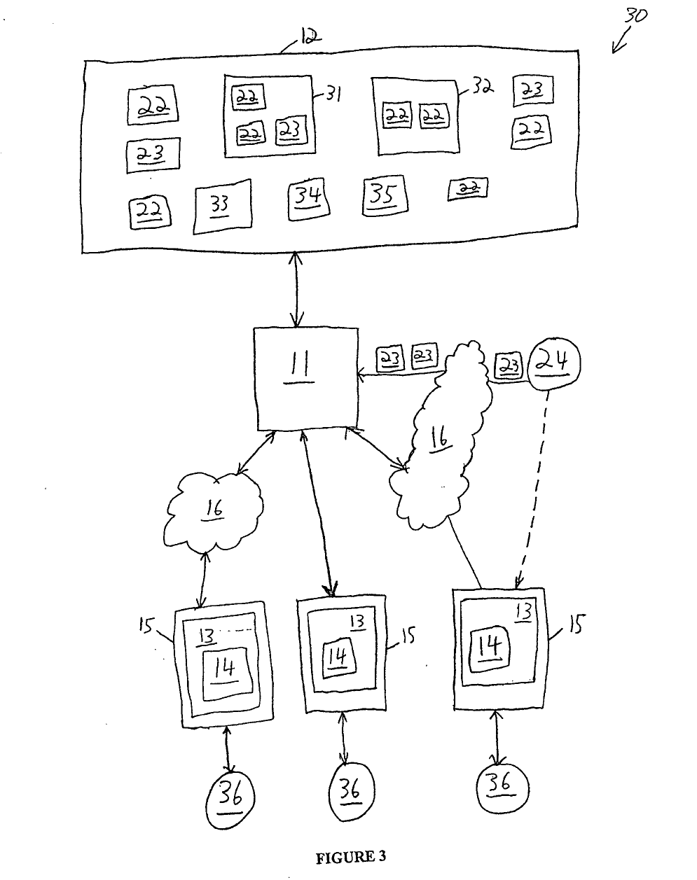

Referring to FIG. 3, in another embodiment, the processor 11 can aggregate and organize various data content 22, pertaining to a particular topic or subject area, into interactive applications or data modules (31 through 35) that can be stored in data store 12. Alternatively, the data modules can be dynamically generated at runtime and displayed on the client websites 13. Each data module can contain specific data content 22 to attract a particular viewing audience, and one or more advertisements 23. For example, data module 31 may contain data content 22 pertaining to lottery data, and lottery results from a variety of geographic areas. Data module 31 may also contain links such as HTML links, which the viewer 36 can select to interact with the data content 22 in module 31. For instance, the viewer 36 may view Florida lottery results by selecting a link in module 31 that pertains to the corresponding lottery. Similarly, as a further example, the processor 11 can configure the data content 22 into a sports data module 32, which may contain various information pertaining to soccer games, baseball games, etc. Data module 33 may contain data content 22 pertaining to weather forecasts over various selectable geographic areas. Module 34 may contain data content 22 pertaining to selectable financial data, such as stocks, bonds, and futures data. Module 35 may contain data content 22 pertaining to entertainment, such as movie schedules, ticket prices, actor biographies, etc.

Each module can also include features that may be unrelated to the data content 22, but that may still be useful to viewers 36. For example, a search field feature can be included in each data module. The search field can be linked to, for instance, a Yahoo or Google search engine. The search field can be included in any module (31 through 35) by adding HTML source text/code to that of the data module, to link and display the search field within the content of the module (31 through 35) on the webpage. For example, the additional HTML source can link the data module to a server, operated by Yahoo or Google, from which the search feature is provided. Once part of the content 22 in any module, the search field can be distributed along with the module by the processor 11 to one or more client websites 13.

In another embodiment, the data content 22 in a particular module can be configured as a slide show presentation. A viewer 36 can start the slideshow by selecting the corresponding link in the module, at which point the webpage 13 can be automatically refreshed with each view of the slideshow. As a result, a new page view can be generated with each display of a view in the slideshow.

Each module can be designed as a stand-alone insert that appeals to a particular segment of the viewing audience. Each module can be designed to encourage viewers to interact with the data content 22 by selecting active links in the module, thereby resulting in a longer visit by the viewer at the website 13, and a higher probability of that interaction occurring.

In an embodiment, the processor 11 can extract data content 22 or one or more data modules (31 through 35) from the data store 12, and can display the content 22 and modules on one or more client websites 13. The processor 11 can extract and display the data content 22 in accordance with pre-determined preferences, which can be stored in data store 12. This embodiment forms a network of client websites 13 that can be interconnected by, and receive content from processor 11. In an embodiment, the processor 11 can also integrate and couple advertisements from providers 24, such as Yahoo and Google, into the data modules (31-35), and then display the modules on the client websites 13. The advertisements 23 appearing in the data modules (31-35), can be in addition to any advertisements that the provider 24 distributes to the client websites 13 directly. The advertisements 23 can be configured to target a particular geographic region. This embodiment can potentially increase the overall number of advertisements that can be presented to viewers 36.

The processor 11 can display data content 22, data modules (31-35), and advertisements on the client websites 13 as self-contained inserts that can provide the client webpage 13 with additional content. The client webpage 13, which can operate on its own platform 15, may also have preexisting content (referred to herein as publisher content) displayed on the webpage 13. The preexisting content may be proprietary to the webpage 13, or may be provided from other sources.

The data content 22 and modules (31-35) can contain at least one link, such as an HTML link, for allowing viewers 36 of the webpage 13 to interact with and manipulate the data content 22. In an embodiment when a viewer 36 selects a link in the data content 22, the processor 11 responds by refreshing the webpage 13, while extracting the requested data content 22 from the data store 12, and presenting the content 22 along with the same or additional advertisements on the refreshed webpage 13. Each time the viewer 36 interacts with the data content 22 by selecting a link, the webpage 13 can be refreshed (reloaded) to update the content 22 and provide a new page view. In other words, the URL of the webpage 13 does not change. This embodiment can increase the number of page views realized by a web property.

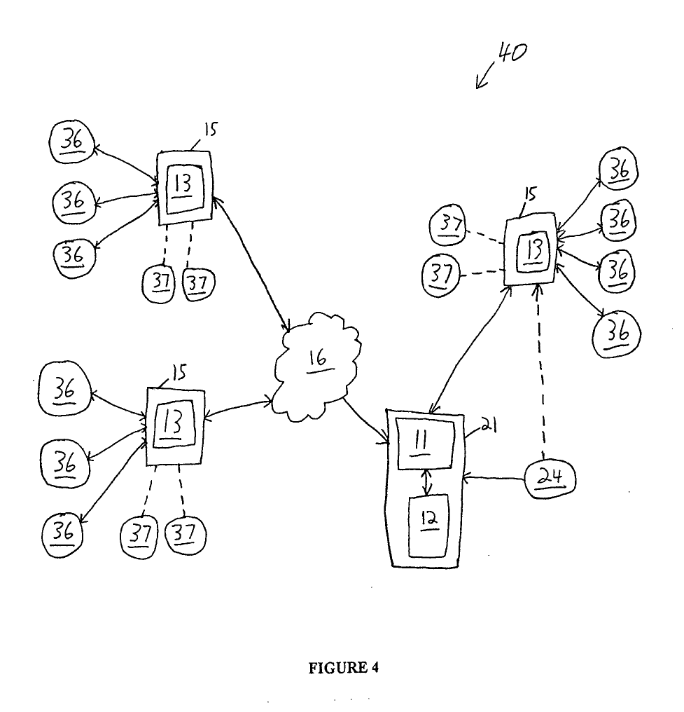

Referring to FIG. 4, network architecture 40 can be utilized to link multiple websites 13 to processor 11. Each client website 13 can be hosted on its own respective platform 15, such as a server, laptop, or wireless device, and can provide web content to its audience of viewers 36. In an embodiment, processor 11 and data store 12 can operate on a server platform 21, and can facilitate the formation of a network of websites 13. Processor 11 can extract the relevant data content 22 for each website 13 from the data store 12, and can couple the data content 22 or modules (31-35) to advertisements 23 provided by advertiser 24. This integration of content 22 and advertisements 23 forms the web content 14 that the processor 11 provides to one or more of the respective websites 13. Each individual client website 13 can thus be linked to processor 11 to form a network of websites.

This network architecture 40, allows an advertiser 24 to simply provide advertisements 23 to processor 11, and the advertisements 23 can then be widely distributed by the processor 11 to an audience of viewers 36, 37 that the advertiser 24 may not have had access to previously. The client website 13 also can benefit, because the data content 22 provided to each website 13 is targeted at a particular audience, and it is likely that additional viewers 37 can be attracted to the participating website 13.

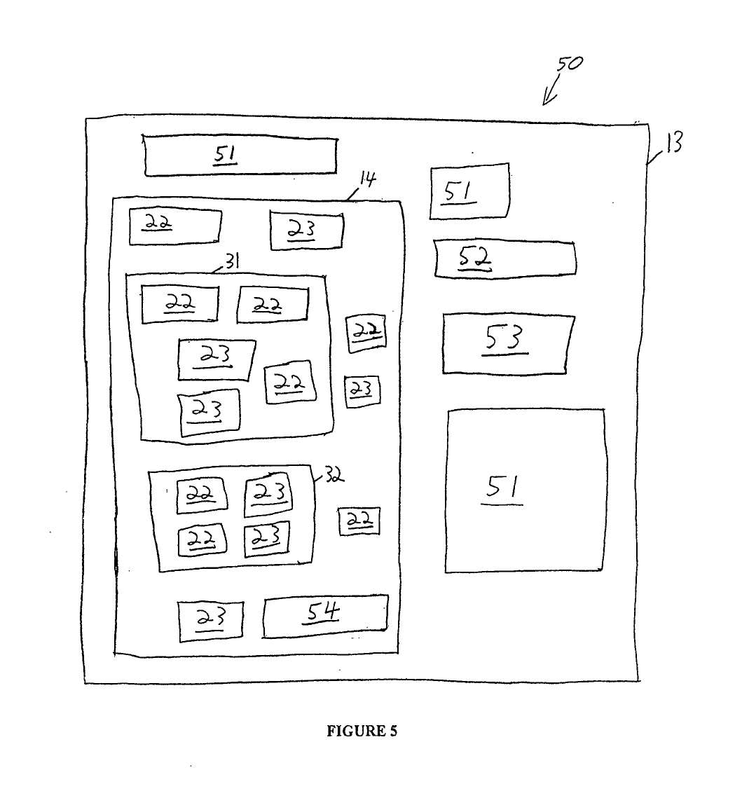

Referring to FIG. 5, which illustrates a view 50 of a webpage 13 having several content items displayed on it from various sources/servers. In an embodiment, the webpage 13 can include publisher content 51, along with various advertisements 52, 53. The processor 11 can provide the web content 14 displayed on the webpage 13. The web content 14 can include data content 22 and advertisements 23. In an embodiment, the web content 14 may include only a data module, such as module 31. The data module 31 can include data content 22, advertisements 23, and associated links. In another embodiment, the web content 14 can include one or more data modules, such as lottery module 31 and sports module 32, and maybe a search field 54, such as a Yahoo or Google search field.

The advertisements 23 displayed within the web content 14 may be specifically targeted to the publisher content 51, or may be specifically targeted to the data content 22. Alternatively, the advertisements 23 may not be specific to any particular content displayed on the webpage 13, and may simply be general advertisements included with the data content 22.

In an embodiment, the advertisements 23 can be presented when the viewer clicks on links in the web content 14 to interact with the data module 31 or other data content 22. Alternatively, the advertisements can be presented when the viewer selects links associated with the advertisements 23. The advertisements can be presented in various formats including video, audio, banners, slide show, pop-up windows, and as a media player application.

In an embodiment, the advertisements 23 can be configured to target viewers interested in a particular geographic region. The advertisements 23 can pertain to and advocate use of products and services within a particular geographic region, or within a particular demographic region. For example, when a viewer clicks on an HTML link in module 31, which may contain lottery results for the State of Florida, an audio or video clip can be launched to promote products and services in Florida. Similarly, if the viewer selects a link in module 31 pertaining to lottery results for the State of Maine, a different audio or video clip promoting Maine products can be presented to the viewer.

In an embodiment, when the viewer 36 interacts with the web content 14, the webpage 13 can be refreshed, and the processor 11 updates the data content 22 and advertisements 23. In an embodiment, the URL of the webpage 13 does not change. The webpage 13 is simply refreshed, thereby generating a page view each time the viewer 36 selects a link in the data content 22. With each refresh of the webpage 13, the same or new advertisements 23 can be displayed in the web content 14 and data modules 31, 32.

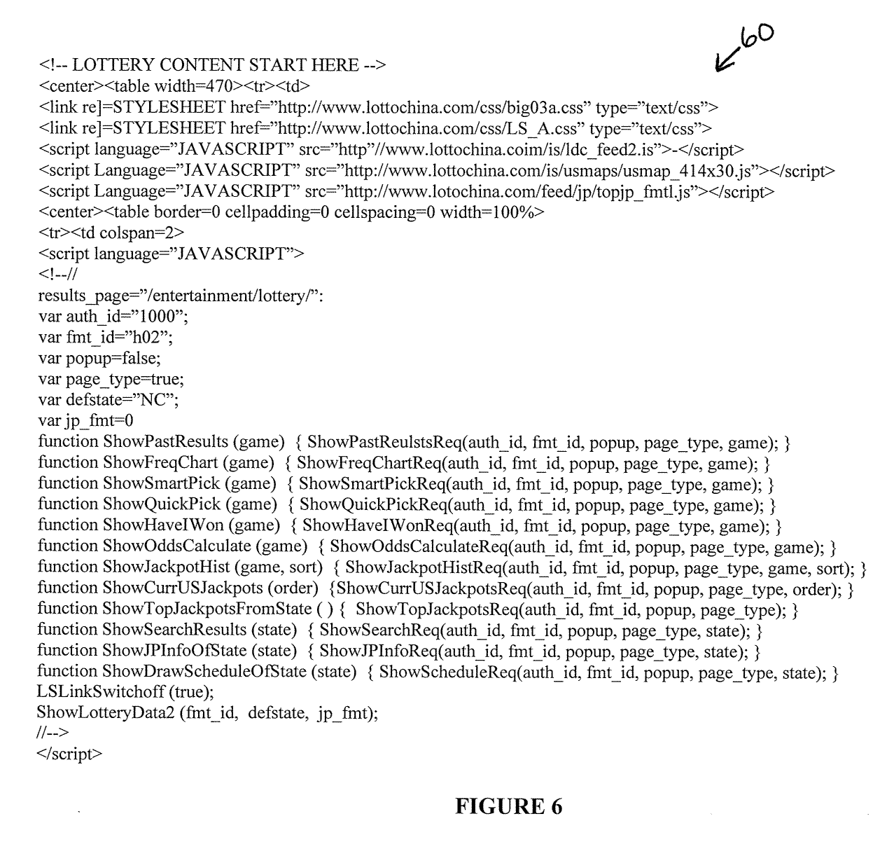

To install and display the web content 14 on the webpage 13, the HTML source code/text of webpage 13 needs to be modified to include additional HTML source code/text that can link processor 11 to webpage 13. The additional HTML source can also determine the appearance, style, and color of the web content 14, as well as its position on the webpage 13. In an embodiment, the additional HTML source can include a JavaScript to interact with processor 11 and to dynamically update and rewrite the webpage 13. FIG. 6 depicts a sample 60 of HTML source code/text that can be inserted into a particular webpage to provide such functionality. Those skilled in the art will appreciate that sample 60 is arbitrary, and is simply provided here for illustrative purposes.

In an embodiment, when a viewer 36 visits webpage 13 the browser utilized by the viewer 36 loads the content of the webpage 13 and downloads a JavaScript from processor 11. If the viewer 36 generates a request for content by selecting any link in the content 14, that event is captured by the JavaScript which utilizes a corresponding function to handle the request. Initially, the JavaScript can save the viewer's request in a cookie and can then refresh (reload) the webpage 13. The saved request may include a variety of information, for instance, a request type field and an identifier field.

While webpage 13 reloads, the JavaScript can extract and evaluate the saved parameters from the cookie, and pass the relevant parameters to processor 11, which identifies and fulfills the viewer's request for content. The processor 11 can utilize the parameters to identify and extract corresponding data content 22 from data store 12. The processor 11 may also couple one or more advertisements 23 to the requested content. The advertisements 23 can be extracted by the processor 11 from data store 12. Alternatively, the processor 11 can request the advertisements 23 at runtime via a function call to the ad server of the provider 24. The ad server of the provider 24 responds to the function call by returning the requested advertisements 23 to the processor 11. The processor 11, via a JavaScript, can then dynamically generate and update/rewrite the webpage 13 to include the requested content in the web content 14. By the time the webpage 13 is finished reloading, the web content 14 is updated to display the content requested by the viewer along with the same or different advertisements 23.

In addition to updating the web content 14, the JavaScript can also be utilized to update the remainder of the webpage 13. In an embodiment the reloading of the webpage 13 does not effect the URL of the webpage 13. The webpage 13 can simply be refreshed, which results in no redirection to another webpage. In this manner a page view is generated with each update of the web content 14, and with each link selection from the viewer 36.

It is intended that any of the data collection and presentation methods described herein may also be used to collect and present other data not specific to lottery results. For example, this collection and presentation methods could be used to collect and display data in the financial arena such as stocks, bonds, indices, currency values, and other areas such as real estates, commodities, fuel prices, and any other data that can be collected and displayed to an audience.

While the invention has been described in connection with the specific embodiments thereof, it will be understood that it is capable of further modification. Furthermore, this application is intended to cover any variations, uses, or adaptations of the invention, including such departures from the present disclosure as come within known or customary practice in the art to which the invention pertains.

We claim:

1. A method of presenting web content on a webpage, the method comprising:
generating a data module by coupling an advertisement to data content;
providing at least one link in the data module for allowing a viewer of the webpage to manipulate the data content;
displaying the data module on a webpage having publisher content; and
refreshing the webpage, in response to receiving a selection of the link from the viewer, to display the manipulated data content and advertisement in the data module on the webpage.

2. A method of claim 1, wherein refreshing the webpage includes displaying additional advertisements in the data module.

3. A method of presenting web content to increase page views of a webpage, the method comprising:
displaying publisher content on a webpage;
exhibiting data content on the webpage;
providing at least one link in the data content for allowing a viewer of the webpage to manipulate the data content; and
refreshing the webpage, in response to receiving a selection of the link from the viewer, to present the manipulated data content on the webpage.

4. A method of claim 3, further comprising coupling at least one advertisement to the data content.

5. A method of claim 4, wherein refreshing the webpage includes displaying additional advertisements on the webpage along with the manipulated data content.

6. A method of presenting a data module on a webpage to increase the number of advertisements presented to a viewer of the webpage, the method comprising:
displaying a data module having data content and at least one advertisement on a webpage having publisher content;
providing at least one link in the data module for allowing a viewer of the webpage to manipulate the data content in the data module; and
refreshing the webpage, in response to receiving a selection of the link from the viewer, to display the manipulated data module on the webpage.

7. A method of claim 6, wherein refreshing the webpage includes displaying additional advertisements in the data module on the webpage.

8. A data module comprising:
data content pertaining to a particular topic for display on a webpage independent of publisher content displayed on the webpage;
an advertisement displayed within the data content;
a link in the data content for allowing a viewer of the webpage to manipulate the data content.

9. A data module of claim 8, wherein the advertisement is a geographically targeted advertisement.

10. A data module of claim 8, wherein the advertisement includes a video component that is presented to the viewer in response to receiving a selection of the link from the viewer.

11. A data module of claim 8, wherein the advertisement includes an audio component that is presented to the viewer in response to receiving a selection of the link from the viewer.

12. A data module of claim 8, wherein the advertisement is specific to the publisher content.

13. A data module of claim 8, wherein the advertisement is specific to the data content.

14. A data module of claim 8, wherein the advertisement includes an associated HTML link that is displayed in the data content.

15. A data module of claim 8, wherein the link is an HTML link.

16. A method of presenting web content on a webpage, the method comprising:
generating a data module by coupling a geographically targeted advertisement to data content;
providing at least one link in the data module for allowing a viewer of the webpage to manipulate the data content;
displaying the data module on a webpage having publisher content; and
refreshing the webpage, in response to receiving a selection of the link from the viewer, to display the manipulated data module on the webpage and present the advertisement to the viewer.

17. A method of claim 16, wherein displaying the data module includes distributing the data module to a plurality of websites.

18. A method of claim 16, wherein refreshing the webpage includes displaying additional advertisements in the manipulated data module.

19. A method of claim 16, wherein refreshing the webpage includes presenting the advertisement to the viewer in an audio format.

20. A method of claim 16, wherein refreshing the webpage includes presenting the advertisement to the viewer in a video format.

21. A method of claim 16, wherein refreshing the webpage includes presenting the advertisement as specific to the publisher content.

22. A method of claim 16, wherein refreshing the webpage includes presenting the advertisement as specific to the data content.
